(19) United States
(12) Patent Application Publication
(10) Pub. No.: US 2010/0218841 A1
(43) Pub. Date: Sep. 2, 2010

(54) 3-D FABRIC AND PREPARING THEREOF

(75) Inventors: Hoo-Sung CHANG, Seoul (KR); Il-Sun RYU, Daegu (KR)

Correspondence Address: SUGHRUE MION, PLLC, 2100 PENNSYLVANIA AVENUE, N.W., SUITE 800, WASHINGTON, DC, 20037, US

(73) Assignees: WOONGJIN CHEMICAL CO., LTD., Seoul (KR); YOUIL CORPORATION CO., LTD., Daegu (KR)

(21) Appl. No.: 12/705,199

(22) Filed: Feb. 12, 2010

(30) Foreign Application Priority Data
Feb. 9, 2009 (KR) 10-2009-0009997

(51) Int. Cl. D03D 3/00; D03D 11/00; E06B 9/386

(52) U.S. Cl. 139/384 A; 139/384 R; 139/408

(57) ABSTRACT

A three-dimensional multilayer fabric is provided. The fabric comprises a surface layer, a backing layer, and an intermediate layer connecting the surface layer and the backing layer. The intermediate layer has a multi-layered structure where a multiple of a fabric is separated each other. The three-dimensional multilayer fabric can be woven on a single loom in a batch operation and undergo transformation between two-dimensional shape and three-dimensional shape. This fabric is applicable as materials for blinds with high light-shielding rate because intermediate portions have a multi-layered structure.

### TECHNICAL FIELD

The present invention relates to fabrics that can create three-dimensional shapes and methods for the production of the fabrics. More specifically, the present invention relates to fabrics, particularly fabrics applicable as materials for blinds with high light-shielding rate due to intermediate portions having a multi-layered structure, that can be woven on a single loom in a batch operation by novel weaving techniques and undergo transformation between two-dimensional and three-dimensional shapes, and methods for the production of the fabrics.

### BACKGROUND ART

Fabrics are typically made from corresponding raw materials and are constructed by weaving, knitting, plaiting or braiding. For example, felt fabrics are produced by the interlocking of fibers. Fabrics are primarily classified into woven fabrics, knitted fabrics, felt fabrics, plaited fabrics, non-woven fabrics, laminated fabrics and molded fabrics by standard production methods thereof.

In a narrow sense, woven fabrics refer to fabrics constructed by interlacing vertical warp threads with horizontal weft threads at right angles. Woven fabrics are the most widely used fabrics for under wears and outer wears. Knitted fabrics are constructed by making sets of threads into loops and combining the loops with one another in forward, backward, left and right directions. Knitted fabrics are rapidly produced by knitting and tend to be loose and elastic when being worn. Strands of fibers are interlocked by heat, moisture, pressure or striking to construct felt fabrics, thus eliminating the need for the use of threads. In plaited, braided and lace fabrics, individual threads are interlaced with sets of threads while sliding in any one direction to attain desired effects. Non-woven fabrics are constructed by the application of adhesive materials, the attachment of fibers through chemical functions on the surface of the fibers, or the attachment of webs or sheets of thermoplastic fibers by heating. Laminated fabrics are constructed by laminating a foam to one or two woven fabrics to achieve improved flexibility and provide a cushiony feeling. The surface areas of molded fabrics are larger than those of the raw materials before extrusion. Molded articles (e.g., clothes) are cushiony, or are in the form of a pile or plate. These articles are very wearable, match the functions of the human body, and are not readily deformed.

The lateral sides of two-dimensional fabrics are not utilized or used. Sewing and other fusion techniques are currently used to impart three-dimensional shapes to fabrics.

Industrial applications of such techniques have been reported. For example, U.S. Pat. No. 3,384,519 suggests a blind comprising two-layered fabrics and a movable blade positioned between the fabrics wherein the fabrics and blade are adhered to the blade by fusion or bonding. The horizontal movement of the blade allows light to enter through the mesh type fabrics, and the vertical movement of the blade blocks light. By the movements of the blade, the amount of light entering the blind can be controlled. In addition, the soft texture and mesh structure of the fabrics enable the blind to shield light in a controllable manner. However, the use of an adhesive or pressure-sensitive adhesive for the adhesion of the blade to the fabrics may cause the problems of indoor environmental pollution. Particularly, long-term use of the blind causes a deterioration in the physical properties of the adhesive or pressure-sensitive adhesive by UV light, resulting in poor adhesion between the blade and the fabrics. In serious cases, the blade is separated from the fabrics.

In an attempt to overcome the above problems, a three-dimensional fabric is suggested in Korean Patent No. 10-0815579. The three-dimensional fabric includes a surface layer, a backing layer, and an intermediate layer connecting the surface layer and the backing layer. The intermediate layer is composed of first intermediate portions and second intermediate portions. The surface layer includes sequential unstitched surface portions and sequential stitched surface portions formed in an alternating and repeating pattern. The unstitched surface portions are essentially composed of surface warp threads only and the stitched surface portions are composed of the surface warp threads and intermediate warp threads. The backing layer includes sequential unstitched backing portions and sequential stitched backing portions formed in an alternating and repeating pattern. The unstitched backing portions are essentially composed of backing warp threads only and the stitched backing portions are composed of the backing warp threads and the intermediate warp threads. The intermediate layer includes sequential intermediate portions composed of the intermediate warp threads only and connected to the stitched surface portions and the stitched backing portions in an alternating and repeating pattern.

The greatest problem of the patent is that the intermediate portions of the three-dimensional fabric have a single-layer structure, so that it is impossible for light to be shield completely. Therefore, the patented fabric is not applicable in various fields such as movie theaters, lecture rooms, presentation rooms, laboratories, and so forth in which light should be shield perfectly.

### DISCLOSURE

### Technical Problem

The present invention has been made in an effort to solve the above problems, and it is an object of the present invention to provide fabrics that can be woven on a single loom in a batch operation by novel weaving techniques and undergo transformation between two-dimensional and three-dimensional shapes, and are applicable as materials for blinds with high light-shielding rate due to intermediate portions having a multi-layered structure and, and methods for the production of the fabrics.

### Technical Solution

Embodiments of the present invention provide a three-dimensional multilayer fabric comprising a surface layer, a backing layer and an intermediate layer connecting the surface layer and the backing layer. The intermediate layer has a multi-layered structure where a multiple of a fabric is separated each other.

Embodiments of the present invention provide a three-dimensional multilayer fabric comprising a surface layer, a backing layer and an intermediate layer connecting the surface layer and the backing layer wherein the intermediate layer has a multi-layered structure where a multiple of fabric is separated each other and is composed of first intermediate portions and second intermediate portions, the surface layer includes sequential unstitched surface portions and sequential stitched surface portions formed in an alternating and repeating pattern, the unstitched surface portions being essentially composed of surface warp threads only and the stitched surface portions being composed of the surface warp threads and intermediate warp threads; the backing layer includes sequential unstitched backing portions and sequential stitched backing portions formed in an alternating and repeating pattern, the unstitched backing portions being essentially composed of backing warp threads only and the stitched backing portions being composed of the backing warp threads and the intermediate warp threads; and the intermediate layer includes sequential intermediate portions composed of the intermediate warp threads only and connected to the stitched surface portions and the stitched backing portions in an alternating and repeating pattern, the intermediate warp threads being woven without interlacing with weft threads on the surfaces of the unstitched backing portions and exposed to the outside, followed by shearing.

Embodiments of the present invention provide a three-dimensional multilayer fabric, comprising a surface layer, a backing layer and an intermediate layer connecting the surface layer and the backing layer wherein the intermediate layer has a multi-layered structure where a multiple of fabric is separated each other and is composed of first intermediate portions and second intermediate portions, the surface layer includes sequential unstitched surface portions and sequential stitched surface portions formed in an alternating and repeating pattern, the unstitched surface portions being essentially composed of surface warp threads only and the stitched surface portions being composed of the surface warp threads and intermediate warp threads; the backing layer includes sequential unstitched backing portions and sequential stitched backing portions formed in an alternating and repeating pattern, the unstitched backing portions being essentially composed of backing warp threads only and the stitched backing portions being composed of the backing warp threads and the intermediate warp threads; and the intermediate layer includes sequential intermediate portions composed of the intermediate warp threads only and connected to the stitched surface portions and the stitched backing portions in an alternating and repeating pattern, the intermediate warp threads being woven without interlacing with weft threads on the surfaces of the unstitched backing portions and the unstitched surface portions and exposed to the outside, followed by shearing.

Embodiments of the present invention provide a three-dimensional multilayer fabric, comprising a surface layer, a backing layer and an intermediate layer connecting the surface layer and the backing layer wherein the intermediate layer has a multi-layered structure where a multiple of fabric is separated each other and is composed of first intermediate portions and second intermediate portions, the surface layer includes sequential unstitched surface portions and sequential stitched surface portions formed in an alternating and repeating pattern, the unstitched surface portions being essentially composed of surface warp threads only and the stitched surface portions being composed of the surface warp threads and intermediate warp threads; the backing layer includes sequential unstitched backing portions and sequential stitched backing portions formed in an alternating and repeating pattern, the unstitched backing portions being essentially composed of backing warp threads and the intermediate warp threads; and the intermediate layer includes sequential intermediate portions composed of the intermediate warp threads only and connected to the stitched surface portions and the stitched backing portions in an alternating and repeating pattern, the intermediate warp threads being interlaced with extra weft threads on the surface layer to form protruding portions exposed on a surface of a fabric, after which the protruding portions are removed to create a three-dimensional shape.

Embodiments of the present invention provide a three-dimensional multilayer fabric, comprising a surface layer, a backing layer and an intermediate layer connecting the surface layer and the backing layer wherein the intermediate layer has a multi-layered structure where a multiple of fabric is separated each other, the surface layer includes sequential unstitched surface portions and sequential stitched surface portions formed in an alternating and repeating pattern, the unstitched surface portions being essentially composed of surface warp threads only and the stitched surface portions being composed of the surface warp threads and a part of intermediate warp threads; the backing layer includes sequential unstitched backing portions and sequential stitched backing portions formed in an alternating and repeating pattern, the unstitched backing portions being essentially composed of backing warp threads only and the stitched backing portions being composed of the backing warp threads and extra warp threads being not composed of the intermediate warp threads; and the intermediate layer includes sequential intermediate portions composed of the intermediate warp threads only and connected to the stitched surface portions and the stitched backing portions in an alternating and repeating pattern, connecting warp threads of the intermediate layer connecting the stitched surface portions and the stitched backing portions being sheared.

Embodiments of the present invention provide a three-dimensional multilayer fabric, comprising a surface layer, a backing layer and an intermediate layer connecting the surface layer and the backing layer wherein the intermediate layer has a multi-layered structure where a multiple of fabric is separated each other and is composed of first intermediate portions and second intermediate portions and the surface layer and the backing, layer are composed of their respective stitched portions where unstitched surface portions and unstitched backing portions are in contact with the intermediate layer, the surface layer and the backing layer are formed of two more warp threads and the first and second intermediate portions are composed of four more even-numbered warp threads, the unstitched surface portions and the unstitched backing portions are formed of two more warp threads, first and third stitched surface portions are formed of the unstitched surface portions and warp threads of the first intermediate portions and second stitched surface portions are formed of the unstitched surface portions and warp threads of the second intermediate portions, first and third stitched backing portions are formed of the unstitched backing portions and warp threads of the second intermediate portions and the second stitched backing portions are formed of the unstitched backing portions and warp threads of the first intermediate portions, the first and second intermediate portions are formed of two more warp threads to separate a multiple of a fabric, connecting warp threads of the intermediate layer exposed to the outside of the backing layer are sheared.

In some embodiments of the present invention, when surface warp threads are 1/2, backing warp threads are 3/4, first intermediate warp threads are 5/6/7/8 and second intermediate warp threads are 9/10/11/12, as indicated by harness numbers, the unstitched surface portions and the unstitched backing portions are essentially composed of 1/2 and 3/4, respectively, the first and third stitched surface portions of the surface layer are composed of 1/2/5/6/7/8, and the second stitched surface portion is composed of 1/2/9/10/11/12, the first and third stitched backing portions of the baking layer are composed of 3/4/9/10/11/12, the second stitched backing portion is composed of 3/4/5/6/7/8, and the first intermediate portions form one fabric layer using 5/6 and the other fabric layer using 7/8 to separate them each other, and the second intermediate portions form one fabric layer using 9/10 and the other fabric layer using 11/12 to separate them each other.

Embodiments of the present invention provide a three-dimensional multilayer fabric, comprising a surface layer, a backing layer and an intermediate layer connecting the surface layer and the backing layer wherein the intermediate layer has a multi-layered structure where a multiple of fabric is separated each other and is composed of first intermediate portions and second intermediate portions and the surface layer and the backing layer are composed of their respective stitched portions where unstitched surface portions and unstitched backing portions are in contact with the intermediate layer, the surface layer and the backing layer are formed of two more warp threads and the first and second intermediate portions are composed of four more even-numbered warp threads, the unstitched surface portions are formed of two more warp threads, the first and second intermediate portions are formed of two more warp threads to separate a multiple of a fabric, first and third stitched backing portions are formed of the unstitched backing portions and warp threads of the first intermediate portions and the second stitched backing portions are formed of the unstitched surface portions and warp threads of the second intermediate portions, the unstitched backing portion till the first stitched backing portion and the stitched portion are composed of the backing layer and warp threads of the second intermediate portions, the unstitched backing portion till the second stitched backing portion and the stitched portion are composed of the backing layer and warp threads of the first intermediate portions, the unstitched backing portion till the third stitched backing portion and the stitched portion are composed of the backing layer and warp threads of the second intermediate portions, the above procedure is sequentially repeated, and protruding portions exposed to the outside of the surface layer are removed.

In some embodiments of the present invention, when surface warp threads are 1/2, backing warp threads are 3/4, first intermediate warp threads are 5/6/7/8 and second intermediate warp threads are 9/10/11/12, as indicated by harness numbers, the unstitched surface portions are essentially composed of 1/2, the first intermediate portions form one fabric layer using 5/6 and the other fabric layer using 7/8 to separate them each other, and the second intermediate portions form one fabric layer using 9/10 and the other fabric layer using 11/12 to separate them each other, the first and third stitched surface portions of the surface layer are composed of 1/2/5/6/7/8, and the second stitched surface portion is composed of 1/2/9/10/11/12, the first and third stitched backing portions of the baking layer are composed of 3/4/9/10/11/12, the second stitched backing portion is composed of 3/4/5/6/7/8, the unstitched backing portion till the first stitched backing portion and the stitched portion are composed of 3/4/9/10/11/12, the unstitched backing portion till the second stitched backing portion and the stitched portion are composed of 3/4/5/6/7/8, the unstitched backing portion till the third stitched backing portion and the stitched portion are composed of 3/4/9/10/11/12, the above procedure is sequentially repeated.

Embodiments of the present invention provide a three-dimensional multilayer fabric, comprising a surface layer, a backing layer and an intermediate layer connecting the surface layer and the backing layer wherein the intermediate layer has a multi-layered structure where a multiple of fabric is separated each other and the surface layer and the backing layer are composed of their respective stitched portions where unstitched surface portions and unstitched backing portions are in contact with the intermediate layer, the surface layer and the backing layer are formed of two more warp threads and intermediate portions are composed of four more even-numbered warp threads, the unstitched surface portions and the unstitched backing portions are formed of two more warp threads, the intermediate portions are formed of two more warp threads to separate a multiple of a fabric, the stitched surface portions are composed of surface warp threads and a part of warp threads of fabric layers, the stitched backing portions are composed of backing warp threads and extra fabric layers, except for the warp threads of the fabric layers being composed of the stitched surface portions, connecting warp threads connecting the stitched surface portions and stitched backing portions are sheared.

In some embodiments of the present invention, when surface warp threads are 1/2, backing warp threads are 3/4, intermediate warp threads are 5/6/7/8, as indicated by harness numbers, the unstitched surface portions are essentially composed of 1/2 and the unstitched backing portions are essentially composed of 3/4, the intermediate portions form one fabric layer using 5/6 and the other fabric layer using 7/8 to separate them each other, the unstitched surface portions are essentially composed of 1/2/6/8, the unstitched backing portion are essentially composed of 3/4/5/7.

In other embodiments of the present invention, the warp thread and/or the weft thread is woven with a low-melting point yarn.

In further embodiments of the present invention, the low-melting point yarn is a grey yarn whose melting point is intentionally lowered by one more method selected from the group consisting of modification of molecular structure, copolymerization, blending, spinning process control or composite spinning so that the surface is allowed to be minutely fused by thermal treatment in the temperature range of about 120° C. to about 190° C.

In other embodiments of the present invention, the warp thread and/or the weft thread is a grey yarn in which a low-melting point yarn and a flame-retardant yarn are mixed or a composite fiber composed of low-melting point portions and flame-retardant portions.

In yet other embodiments of the present invention, the fabric is further thermally treated to achieve improved shape stability and enhanced stiffness.

In further embodiments of the present invention, the surface layer and the backing layer are formed into a mesh structure by weaving.

In other embodiments of the present invention, the intermediate layer is denser than the surface layer and the backing layer.

In further embodiments of the present invention, a cloth is provided using the three-dimensional multilayer fabric.

In yet further embodiments of the present invention, an article is provided using the three-dimensional multilayer fabric.

In other embodiments of the present invention, a blind is provided using the three-dimensional multilayer fabric.

### ADVANTAGEOUS EFFECTS

The fabrics and the methods according to the embodiments of the present invention have the following advantageous effects.

The fabrics can be transformed from two-dimensional shape to and three-dimensional shape according to a conventional weaving method. The three-dimensional multilayer fabric according to the present invention can shield light perfectly due to intermediate portions having a multi-layered structure so that it is applicable in various fields such as movie theaters, lecture rooms, presentation rooms, laboratories, and so forth in which light should be shield perfectly.

Additionally, the design, color depth and light-shielding effects of the fabrics can be effectively varied through the transformation between two-dimensional and three-dimensional shapes.

### DESCRIPTION OF DRAWINGS

FIG. 1 is a cross-sectional view of a fabric according to a preferred embodiment of the present invention along the running direction of warp threads;

FIG. 2 is a conceptual sectional view illustrating the production of the fabric according to a first embodiment of the present invention;

FIG. 3 is a conceptual sectional view illustrating the production of the fabric as indicated by harness numbers according to a first embodiment of the present invention;

FIG. 4 is a conceptual sectional view illustrating the production of the fabric according to a second embodiment of the present invention;

FIG. 5 is a cross-sectional view of the fabric according to a third embodiment of the present invention along the running direction of warp threads;

FIG. 6 is a conceptual sectional view illustrating the production of the fabric as indicated by harness numbers according to the third embodiment of the present invention;

FIG. 7 is a cross-sectional view of the fabric according to a fourth embodiment of the present invention along the running direction of warp threads;

FIG. 8 is a conceptual sectional view illustrating the production of the fabric as indicated by harness numbers according to the fourth embodiment of the present invention; and

FIG. 9 is a flow chart illustrating the production of the fabric according to the embodiments of the present invention.

<Brief explanation of essential parts of the drawings>

| | |
|---|---|
| 100: Surface layer | 110: Stitched surface portions |
| 120: Unstitched surface portions | 200: Backing layer |
| 210: Stitched backing portions | 220: Unstitched |
| | backing portions |
| 300: Intermediate layer | 400: Protruding portions |

### BEST MODE

Preferred embodiments of the present invention will now be described in detail with reference to the accompanying drawings. It should be noted that whenever possible, the same reference numerals will be used throughout the drawings and the description to refer to the same or like parts. In describing the present invention, detailed descriptions of related known functions or configurations are omitted in order to avoid making the essential subject of the invention unclear.

As used herein, the terms “about”, “substantially”, etc. are intended to allow some leeway in mathematical exactness to account for tolerances that are acceptable in the trade and to prevent any unconscientious violator from unduly taking advantage of the disclosure in which exact or absolute numerical values are given so as to help understand the invention.

The term “fabrics” is defined to include woven fabrics, knitted fabrics, felt fabrics, plaited fabrics, non-woven fabrics, laminated fabrics and molded fabrics. Woven fabrics are exemplified in order to better understand the embodiments of the present invention. Thus, it is to be understood that the woven fabrics are produced by the interlacing of warp threads and weft threads. The expression “warp threads only are woven” is used herein to mean that the warp threads are interlaced with well threads, but the expression ‘not interlaced with weft threads’ is not applied thereto.

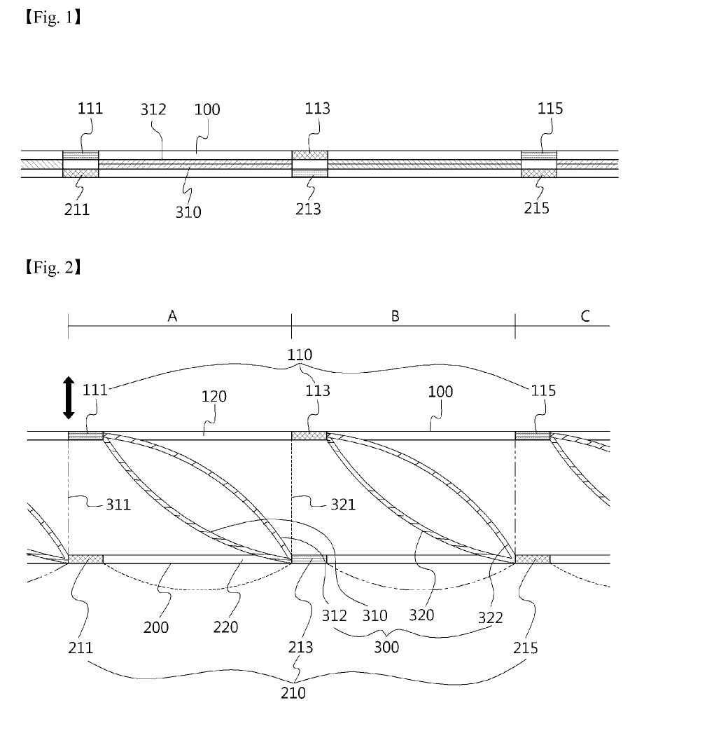

The three-dimensional multilayer fabric can be formed in a three-layered structure. In actuality, the fabrics are formed as illustrated FIG. 1, for convenience of explanation, a surface layer 100 and a backing layer 200 are separated as shown FIGS. 2 to 8.

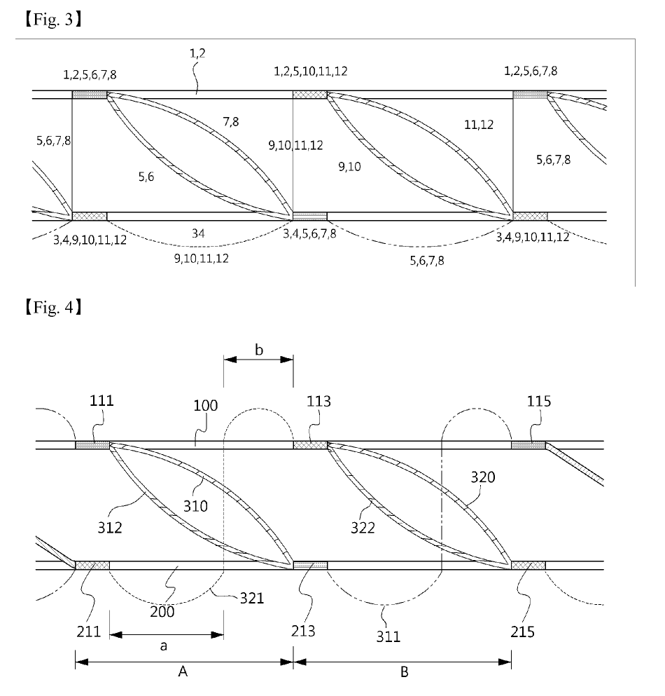

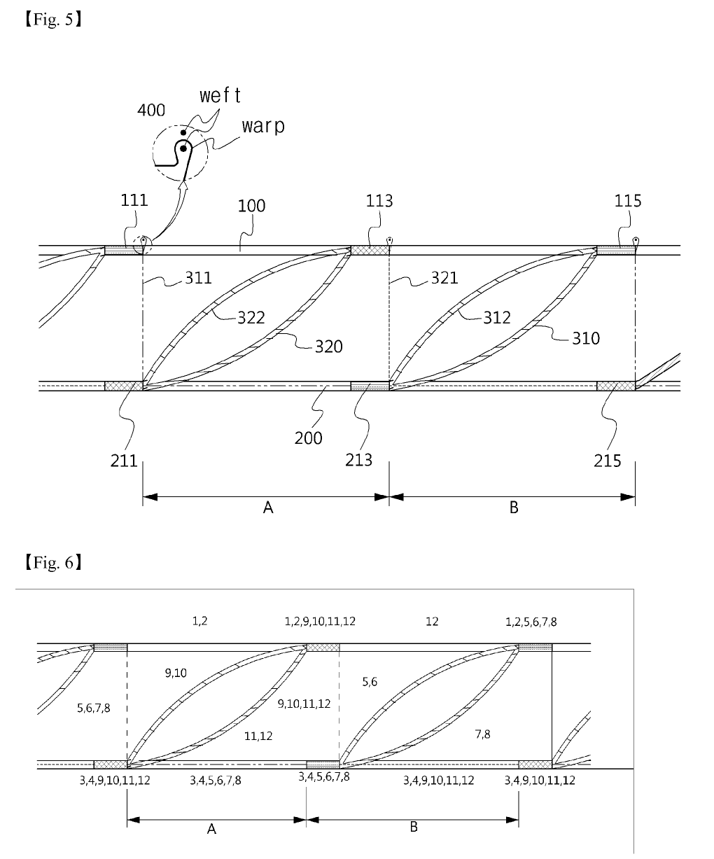

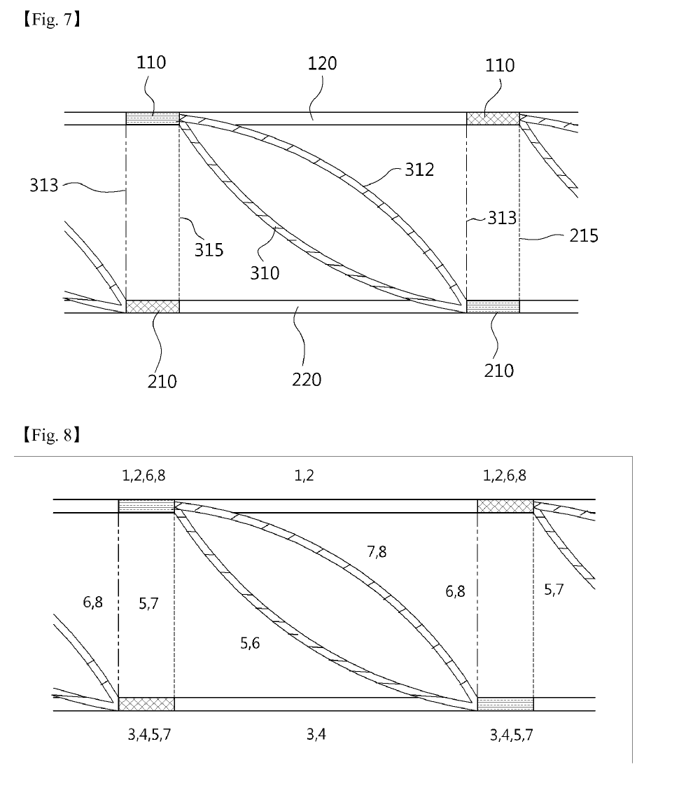

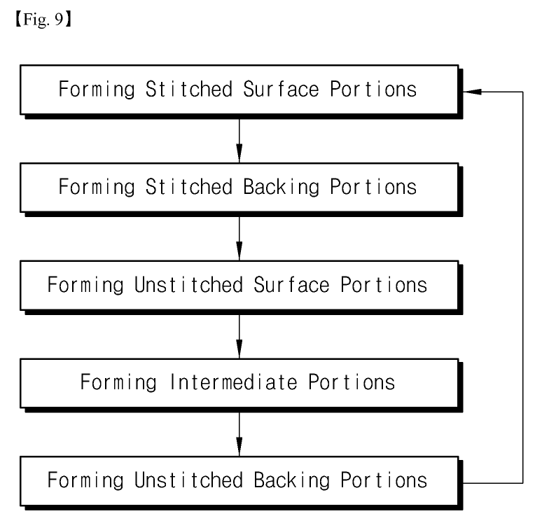

FIG. 1 is a cross-sectional view of a fabric according to a preferred embodiment of the present invention along the running direction of warp threads. FIG. 2 is a conceptual sectional view illustrating the production of the fabric according to a first embodiment of the present invention. FIG. 3 is a conceptual sectional view illustrating the production of the fabric as indicated by harness numbers according to a first embodiment of the present invention. FIG. 4 is a conceptual sectional view illustrating the production of the fabric according to a second embodiment of the present invention. FIG. 5 is a cross-sectional view of the fabric according to a third embodiment of the present invention along the running direction of warp threads. FIG. 6 is a conceptual sectional view illustrating the production of the fabric as indicated by harness numbers according to the third embodiment of the present invention. FIG. 7 is a cross-sectional view of the fabric according to a fourth embodiment of the present invention along the running direction of warp threads. FIG. 8 is a conceptual sectional view illustrating the production of the fabric as indicated by harness numbers according to the fourth embodiment of the present invention. FIG. 9 is a flow chart illustrating the production of the fabric according to the embodiments of the present invention. The present invention will be described hereinafter along the running direction of warp threads.

The three-dimensional multilayer fabric according to the present invention comprises a surface layer 100, a backing layer 200 and an intermediate layer 300 connecting the surface layer 100 and the backing layer 200.

The surface layer 100 includes stitched surface portions 110 and unstitched surface portions 120 formed in an alternating and repeating pattern, and the backing layer 200 includes stitched backing portions 210 and unstitched backing portions 220 formed in an alternating and repeating pattern. The unstitched surface portions 120 and the unstitched backing portions 220 are composed of surface warp threads and backing warp threads only, respectively. The stitched surface portions 110 can be composed of the surface warp threads and intermediate warp threads. The stitched backing portions 210 can be composed of the backing warp threads and the intermediate warp threads.

As shown in FIGS. 2 to 6, the intermediate layer includes a first intermediate portion and a second intermediate portion, which are only composed of different kinds of warp threads, repeatedly, i.e. ‘first intermediate warp threads’ and ‘second intermediate warp threads’, which are four more even-numbered warp threads. As shown in FIGS. 7 and 8, the first intermediate portions are repeatedly formed to create the three-dimensional multilayer fabric.

The constituent intermediate warp threads of the intermediate layer are composed of four more even-numbered warp threads. For example, in case that two-layered fabric forms the intermediated layer, four warp threads are required at a minimum. As shown in FIG. 2, the first intermediate portions 310 and 312 composed of two-layered fabric and the second intermediate portions 320 and 322 are formed. Each of the fabric layer of the intermediate portions is separated from each other.

The three-dimensional multilayer fabric can be formed in various production methods. The fabrication procedure, as shown in FIG. 9, is carried out by the steps of forming the stitched surface portions, forming stitched backing portions, forming the unstitched surface layer, forming the intermediate layer, and forming the unstitched backing layer.

The unstitched surface portions 120 and the unstitched backing portions 220 are essentially composed of independent warp threads (i.e. the surface warp threads and the backing warp threads) in the first embodiment of the present invention of FIGS. 2 and 3. Starting from zone A of FIG. 2, the principle of weaving will be explained with regard to the formation of the layers using the respective warp threads. The surface warp threads are woven with the first intermediate warp threads forming the first intermediate portions 310 and 312 to form a first stitched surface portion 111. The first intermediate warp threads only are woven to form the first intermediate portion 310 and 312, and are then woven with the backing warp threads to form a second stitched backing portion 213 on the backing layer 200. Thereafter, the first intermediate warp threads are woven without interlacing with the weft threads and the backing warp threads only are woven to form the unstitched backing portion 220 in unstitched backing portions of zone B. The first intermediate warp threads (connecting warp threads 311) woven without interlacing the weft threads at the starting point of a third stitched surface portion 115 connect the starting point of a third stitched backing portion 215 to the starting point of the third stitched surface portion 115 and are woven together with the surface warp threads to form the third stitched surface portion 115. The subsequent procedure is carried out in the same manner as after the formation of the first stitched surface portion 111.

On the other hand, a first stitched backing portion 211 of the backing layer 200 is formed at the same vertical position as the first stitched surface portion 111. The backing layer 200 is essentially composed of the backing warp threads only. The first stitched backing portion 211 is composed of the backing warp threads and the second intermediate warp threads. Thereafter, the second intermediate warp threads are woven without interlacing the weft threads and the backing warp threads are interlaced with the weft threads to form the unstitched baking portion 220 (zone A). The second intermediate warp threads (connecting warp threads 321) woven without interlacing the weft threads are woven together with the surface warp threads at the starting point of the second stitched backing portion 213 to form a second stitched surface portion 113 of the surface layer 100. At this time, the connecting warp threads 321 serve to connect the second stitched surface portion 113 and the second stitched backing portions 213. Herein, the second stitched surface portion 113 may be formed at the same vertical position as the second stitched backing portion 213. The second intermediate warp threads having participated in the formation of the second stitched surface portion 113 are woven with only the second intermediate warp threads to form the intermediate layer (herein, the second intermediate portion in zone B) and are woven with the backing warp threads to form the third stitched backing portion 215. The subsequent procedure is carried out in the same manner as in zone A. The second intermediate portion is formed of the fabric layer separated the same as the first intermediate portion.

In FIG. 3, the method for weaving the fabric according to the present invention is simplified as indicated by harness numbers. As illustrated in FIG. 3, when the surface warp threads are 1/2, the backing warp threads are 3/4, the first intermediate warp threads are 5/6/7/8 and the second intermediate warp threads are 9/10/11/12, as indicated by harness numbers, the unstitched surface portions 120 and the unstitched backing portions 220 are essentially composed of 1/2 and 3/4, respectively, the first and third stitched surface portions of the surface layer 111 and 115 are composed of 1/2/5/6/7/8, and the second stitched surface portion 113 is composed of 1/2/9/10/11,12, the first and third stitched backing portions 211 and 215 of the backing layer are composed of 3/4/9/10/11/12, the second stitched backing portion 213 is composed of 3/4/5/6/7/8, and the first intermediate portions 310 and 312 are composed of 5/6/7/8. In addition, the first intermediate portions form one fabric layer using 5/6 and the other fabric layer using 7/8 to separate them each other. The second intermediate portions 320 and 322 are composed of 9/10/11/12 and the second intermediate portions form one fabric layer using 9/10 and the other fabric layer using 11/12 to separate them each other.

Referring to FIGS. 2 and 3, the production of the fabric according to the present invention will be explained in accordance with the actual weaving procedure. The first stitched surface portions 111 in zone A are started. That is, the surface warp threads and the first intermediate warp threads are once interlaced with the weft threads while shedding along a harness to form the first stitched surface portion 111. Thereafter, the backing warp threads and the second intermediate warp threads are interlaced with the weft threads during shedding to form the second stitched backing portion. This procedure is sequentially and repeatedly continued until the respective stitched portions are formed in accordance with the pre-designed length (for example, 1 cm) of the stitched portions.

After the formation of the stitched portions 111 and 211 is completed, the surface warp threads only are interlaced with the weft threads to form the unstitched surface portion 120 in zone A and the first intermediate warp threads only are interlaced with the weft threads to form the first intermediate portion. Further, only the backing warp threads are interlaced with the weft threads to form the unstitched backing portion 220. This procedure is sequentially and repeatedly continued as the pre-designed length just before the respective second stitched portions are formed.

The weaving in zone B is the same as in zone A except that different kinds of warp threads are used. The second intermediate warp threads are woven with the surface warp threads to form the second stitched surface portion 113 and the first intermediate warp threads are woven with the backing warp threads to form the second stitched backing portion 213. Thereafter, the surface warp threads are woven to form the unstitched surface portion, the second intermediate warp threads are woven to form the second intermediate portion 320, and the backing warp threads are woven to form the unstitched backing portion. These portions are formed sequentially and repeatedly by weaving in the same manner as in zone A.

The interlacing between the warp threads and the weft threads is basically conducted once, but the number of interlacing may vary in each layer depending on the fineness and texture of the warp/weft threads. In addition, the surface layer is first formed by weaving, but it should be understood that the intermediate layer or the backing layer can be formed before the surface layer.

The surface layer is connected to the backing layer by the connecting warp threads 311 and 321, thus making it impossible to create a three-dimensional shape. Accordingly, the removal of the connecting warp threads 311 and 321 is required to create a three-dimensional shape. FIG. 4 illustrates a state in which the connecting warp threads 311 and 321 are removed. By the removal of the connecting warp threads, the surface layer 100 and the backing layer 200 are connected to each other in an alternating manner through the intermediate layer 300. This alternating connection allows the fabric to create a three-dimensional shape. Specifically, the first stitched surface portion 111 is connected to the second stitched backing portion 213 through the first intermediate portion 310 and 312, and the second stitched surface portion 113 is connected to the third stitched backing portion 215 through the second intermediate portion 320 and 322. This structure may be repeated in a continuous pattern.

FIG. 4 is a conceptual sectional view illustrating the production of the fabric according to the second embodiment of the present invention. The basic principle of weaving is the same as in the fabric of the previous embodiment except that the connecting warp threads 311 and 321 are stitched at different points. First, the weaving in zone A will be explained. The second intermediate warp threads having participated in the formation of the first stitched backing portion 211 are woven without interlacing with the weft threads to form the unstitched backing portion 220 in sub-zone (a), as explained in the previous embodiment. In the first embodiment, the second intermediate warp threads are moved to the surface layer 100 and are woven together with the surface warp threads at the starting point of the second stitched backing portion 213 to form the second stitched surface portion 113. In the present embodiment, the second intermediate warp threads are moved from any point of the zone, where only the unstitched backing portion 220 is formed, to the surface layer 110, and then are woven without interlacing with the weft threads in sub-zone (b) of the unstitched surface portion 120 to form the second stitched surface portion 113. Thereafter, the second intermediate warp threads are woven together with surface warp threads in a zone where the second stitched surface portion 113 is formed, as described in the previous embodiment. The weaving of the first intermediate warp threads is also carried out in the same manner as in the previous embodiment.

Some of the warp threads that are not interlaced with the weft threads are exposed to the surfaces of the surface layer and the backing layer. In the first embodiment, some of the warp threads that are not interlaced with the weft threads are exposed to only the surface of the backing layer.

Since the surface layer is connected to the backing layer by the connecting warp threads 311 and 321 according to the first and second embodiments, the removal of the connecting warp threads 311 and 321 is required to create a three-dimensional shape. The fabric of the present embodiment has the advantage that the introduction of the connecting warp threads arising from the random movement of fibers after cutting can be prevented.

The connecting warp threads can be removed by various methods, for example, shearing. Specifically, some of the warp threads exposed from the backing layer 200 without interlacing with the weft threads can be cut and removed by suction.

FIGS. 5 to 6 illustrate a fabric according to the third embodiment of the present invention. The weaving and the basic structure of the fabric are the same as the foregoing embodiments except that the intermediate warp threads run in different directions during weaving.

First, the surface warp threads are woven without interlacing with the other warp threads to form the unstitched surface portion 120 of the surface layer 100 and are then woven with the second intermediate warp threads to form the second stitched surface portion 113 in zone A. The formation of the second intermediate portion 320 by weaving only the second intermediate warp threads is the same as in the foregoing embodiments. Thereafter, the connecting warp threads 321 of the second intermediate portion 320 are exposed to the surface of the surface layer to form protruding portions 400. As illustrated in the enlarged partial view of the FIG. 5, two weft threads are woven upwardly and downwardly with respect to the warp threads 321 to surround the warp threads 321. The connecting warp threads 321 interlaced with the weft threads are woven together with the backing warp threads to form the backing layer 200 and are woven together with the backing warp threads to form the third stitched backing portion 215 in zone B. Again, the backing warp threads are woven together with the first intermediate warp threads to form the backing layer 200 and are then woven with the first intermediate warp threads to form the second stitched backing portion 213 in zone A. Thereafter, the first intermediate warp threads are woven to form the first intermediate portion 310, woven with the surface warp threads to form the third stitched surface portion 115 and woven with extra weft threads to form protruding portions 400 exposed to the surface of the third stitched surface portion 115 in zone B. The first intermediate warp threads are woven with the backing warp threads to form the backing layer after the third stitched backing portion 215. That is, in the present embodiment, the first or second intermediate warp threads are woven with the backing warp threads to form the unstitched backing portions 220 and the stitched backing portions 210 of the backing layer, and the second or first intermediate warp threads are woven with the backing warp threads to form the unstitched backing portions 220 and the stitched backing portions 210 of the backing layer in an alternating and repeating pattern in the other zone.

In FIG. 6, the method for weaving the fabric according to the present invention is simplified as indicated by harness numbers. As illustrated in FIG. 6, when the warp threads of the surface layer 100 are 1/2, the warp threads of the backing layer 200 are 3/4, the warp treads of the first intermediate portion 310 are 5/6/7/8 and the warp treads of the second intermediate portion 320 are 9/10/11/12, as indicated by harness numbers, the surface layer 100 are essentially composed of 1/2, the first and third stitched surface portions of the surface layer 111 and 115 are composed of 1/2/5/6/7/8, and the second stitched surface portion 113 is composed of 1/2/9/10/11,12. The unstitched backing portion till the first stitched backing portion 211 and the stitched portion are composed of 3/4/9/10/11/12. The unstitched backing portion till the second stitched backing portion 213 and the stitched portion are composed of 3/4/5/6/7/8, the unstitched backing portion till the third stitched backing portion 215 and the stitched portion are composed of 3/4/9/10/11/12. The above procedure is sequentially repeated. The first and second intermediate portions are composed of 5/6/7/8 and 9/10/11/12, respectively. Since the surface layer is connected to the backing layer by the connecting warp threads 311 and 321, it is necessary to remove the connecting warp threads. As mentioned earlier, the connecting warp threads can be removed by shearing. Alternatively, the connecting warp threads can be removed in a more convenient manner by removing the warp threads 400 exposed to the surface layer. That is, the connecting warp threads exposed to the surface layer are fixed by the weft threads. The weft threads are continuously exposed together with the connecting warp threads in the width direction. When it is intended to move upwardly and remove the weft threads exposed to the surface layer, the connecting warp threads interlaced together with the weft threads are also moved upwardly and cut at the respective stitched portions. As a result, the connecting warp threads can be completely removed together with the weft threads.

FIGS. 7 to 8 illustrate a fabric according to the fourth embodiment of the present invention. In previous first to third embodiments, the intermediate portions are composed of the first and second intermediate portions. That is, the three-dimensional multilayer fabric is formed employing the intermediate portions having different warp threads and being repeated. In this method, there are several warp threads not woven with the weft threads and sheared warp threads, so that procedure can be complex.

In the fourth embodiment, the weaving and the basic structure of the fabric such that the surface layer, the backing layer, and the intermediate layer having a multi-layered structure where a multiple of fabrics are separated each other, are the same as the foregoing embodiments except that the warp threads composed of the stitched portions.

The unstitched surface portions 120 and the unstitched backing portions 220 are essentially composed of independent warp threads.

The stitched surface portions 110 are composed of the warp threads of the unstitched surface portions 120 and a part of the warp threads of the intermediate portions 310 and 312. The stitched backing portions 210 are composed of the warp threads of the unstitched backing portions 220 and extra warp threads being not composed of the stitched surface portions 110 among the warp threads composed of the intermediate portions 310 and 312. In the event that the fabric layer is composed of two warp threads, one is composed of the stitched surface portions and the other is composed of the stitched backing portions.

The warp threads composed of the stitched surface portions 110 form the intermediate portions and form prior connecting warp threads 313 connecting the stitched surface portions 110 without the weft threads at a starting point of the stitched backing portion 210 and then faun the stitched surface portions 110 together with the warp threads of the unstitched surface portions 120.

The warp threads composed of the stitched backing portions 210 are woven with the warp threads of the unstitched backing portion 220 to form the stitched backing portions 210 and form a post connecting warp threads 315 connecting the stitched surface portions 110 without the weft threads at an end point of the stitched backing portion 210 and then form the intermediate portions 310 and 312.

In FIG. 8, the method for weaving the fabric according to the present invention is simplified as indicated by harness numbers. As illustrated in FIG. 8, when the surface warp threads are 1/2, the backing warp threads are 3/4, the first intermediate warp threads are 5/6/7/8, as indicated by harness numbers, the unstitched surface portions 120 and the unstitched backing portions 220 are essentially composed of 1/2 and 3/4, respectively, the stitched surface portions 110 are composed of 1/2/6/8, and the stitched backing portions 210 are composed of 3/4/5/7. In addition, the intermediate portions 310 and 312 are composed of 5/6/7/8 and the intermediate portions form one fabric layer using 5/6 and the other fabric layer using 7/8 to separate them each other.

The procedure according to the fourth embodiment is simple as compared to the first to third embodiments as aforementioned. The three-dimensional multiplayer fabric according to the fourth embodiment has advantages that there is no warp threads exposed to the outside of the surface layer and the backing layer and the protrusion portions are not formed while two connecting warp threads for connecting the stitched surface portions and the stitched backing portions are formed.

In the fabrics according the fourth embodiment, since the stitched surface portions are combined with the stitched backing portions by the prior and post connecting warp threads 313 and 315, it is necessary to remove the prior and post connecting warp threads 313 and 315 in order to embody three-dimensional shape

The fabric may be thermally treated before or after the shearing to achieve improved shape stability and enhanced stiffness. The thermal treatment is preferably carried out before shearing to make the fabric stiffer. When the thermal treatment is carried out after shearing, an excessive stress (e.g., cutting) is applied to the fabric in the state where the multiple layers are adhered, and as a result, the fabric may be damaged.

To avoid damage to the fabric, the warp thread and/or the weft thread is woven with a low-melting point yarn. As the low-melting point yarn, there may be used a grey yarn whose melting point is intentionally lowered by modification of molecular structure, copolymerization, blending, spinning process control or composite spinning so that the surface can be minutely fused by thermal treatment in the temperature range of about 120° C. to about 190° C. Specifically, as the grey yarn, Korean Patent No. 289414 suggests a copolyester-based binder fiber prepared by copolymerizing terephthalic acid or its ester-forming derivative, ethylene glycol and neopentyl glycol. Further, the low-melting yarn produced by composite spinning is composed of a core portion and a sheath portion. The core portion serves as a support and the sheath portion is fused during thermal treatment. As the low-melting yarn, Korean Patent No. 587122 suggests a heat-fusible composite fiber comprising a low-melting point ingredient and a high-melting point ingredient wherein the low-melting point ingredient forms continuously at least a part of the fiber surface in the fiber direction, has a glass transition temperature higher than 60° C. and is composed of a mixture of 1 to 20 wt % of polyolefin and 80 to 99 wt % of a copolyester having 50 to 70 mol % of polyethylene terephthalate units.

As the warp thread and/or the weft thread, there can be used a mixture in which a low-melting point yarn and a flame-retardant yarn are mixed, a composite fiber (e.g., sheath-core type, split type, multiple sea-island type, etc.) composed of a low-melting point portion and a flame-retardant portion, or a blended spun yarn of a low-melting point yarn and a flame retardant yarn. In this case, the fabrics can be utilized as industrial materials, particularly, curtain sheets and blinds. At this time, the ratio between the low-melting point portion and the flame-retardant portion or between the low-melting point yarn and the flame-retardant yarn is preferably from 15:85 to 50:50 (w/w). When the flame retardant portion (or yarn) is present in the amount of less than 50 wt %, the flame retardance of the fabric is deteriorated. Meanwhile, when the flame retardant portion (or yarn) is present in the amount exceeding 85%, the degree of fusion of the flame retardant portion (or yarn) during thermal treatment is low, and as a result, improvement in the stiffness of the fabric is negligible.

In the fabrics according to the present invention, the surface layer, the backing layer and the intermediate layer may have different texture densities. For example, the surface layer and the backing layer are configured to have a mesh structure by weaving, and the intermediate layer is configured to be denser than the surface layer and the backing layer. When the fabric has a structure in which the inner and outer portions are not exposed, as illustrated in FIG. 1, it does not create a three-dimensional shape. When the fabric has a structure in which the intermediate layer is movable in the vertical direction with respect to the surface layer and the backing layer and the inner and outer portions of the layers are exposed due to the mesh structure of the surface layer and the backing layer, it can create a three-dimensional shape. This structure indicates that the fabric can be utilized as a material for light shielding or security. In addition, the fabric can impart new functions to clothes. When the warp threads and the weft threads in the surface layer and the backing layer are positioned at intervals of 0.2 to 2 mm, more desirable effects of the fabric can be attained. Further, it is to be appreciated that the texture structure and design of the surface layer, the backing layer and the intermediate layer can be varied.

1. A three-dimensional multilayer fabric, comprising a surface layer, a backing layer and an intermediate layer connecting the surface layer and the backing layer wherein the intermediate layer has a multi-layered structure where a multiple of a fabric is separated each other.

2. A three-dimensional multilayer fabric, comprising a surface layer, a backing layer and an intermediate layer connecting the surface layer and the backing layer wherein the intermediate layer has a multi-layered structure where a multiple of fabric is separated each other and is composed of first intermediate portions and second intermediate portions, the surface layer includes sequential unstitched surface portions and sequential stitched surface portions formed in an alternating and repeating pattern, the unstitched surface portions being essentially composed of surface warp threads only and the stitched surface portions being composed of the surface warp threads and intermediate warp threads; the backing layer includes sequential unstitched backing portions and sequential stitched backing portions formed in an alternating and repeating pattern, the unstitched backing portions being essentially composed of backing warp threads only and the stitched backing portions being composed of the backing warp threads and the intermediate warp threads; and the intermediate layer includes sequential intermediate portions composed of the intermediate warp threads only and connected to the stitched surface portions and the stitched backing portions in an alternating and repeating pattern, the intermediate warp threads being woven without interlacing with weft threads on the surfaces of the unstitched backing portions and exposed to the outside, followed by shearing.

3. A three-dimensional multilayer fabric, comprising a surface layer, a backing 30 layer and an intermediate layer connecting the surface layer and the backing layer wherein the intermediate layer has a multi-layered structure where a multiple of fabric is separated each other and is composed of first intermediate portions and second intermediate portions, the surface layer includes sequential unstitched surface portions and sequential stitched surface portions formed in an alternating and repeating pattern, the unstitched surface portions being essentially composed of surface warp threads only and the stitched surface portions being composed of the surface warp threads and intermediate warp threads; the backing layer includes sequential unstitched backing portions and sequential stitched backing portions formed in an alternating and repeating pattern, the unstitched backing portions being essentially composed of backing warp threads only and the stitched backing portions being composed of the backing warp threads and the intermediate warp threads; and the intermediate layer includes sequential intermediate portions composed of the intermediate warp threads only and connected to the stitched surface portions and the stitched backing portions in an alternating and repeating pattern, the intermediate warp threads being woven without interlacing with weft threads on the surfaces of the unstitched backing portions and the unstitched surface portions and exposed to the outside, followed by shearing.

4. A three-dimensional multilayer fabric, comprising a surface layer, a backing layer and an intermediate layer connecting the surface layer and the backing layer wherein the intermediate layer has a multi-layered structure where a multiple of fabric is separated each other and is composed of first intermediate portions and second intermediate portions, the surface layer includes sequential unstitched surface portions and sequential stitched surface portions formed in an alternating and repeating pattern, the unstitched surface portions being essentially composed of surface warp threads only and the stitched surface portions being composed of the surface warp threads and intermediate warp threads; the backing layer includes sequential unstitched backing portions and sequential stitched backing portions formed in an alternating and repeating pattern, the unstitched backing portions being essentially composed of backing warp threads and the intermediate warp threads; and the intermediate layer includes sequential intermediate portions composed of the intermediate warp threads only and connected to the stitched surface portions and the stitched backing portions in an alternating and repeating pattern, the intermediate warp threads being interlaced with extra weft threads on the surface layer to form protruding portions exposed on a surface of a fabric, after which the protruding portions are removed to create a three-dimensional shape.

5. A three-dimensional multilayer fabric, comprising a surface layer, a backing layer and an intermediate layer connecting the surface layer and the backing layer wherein the intermediate layer has a multi-layered structure where a multiple of fabric is separated each other, the surface layer includes sequential unstitched surface portions and sequential stitched surface portions formed in an alternating and repeating pattern, the unstitched surface portions being essentially composed of surface warp threads only and the stitched surface portions being composed of the surface warp threads and a part of intermediate warp threads; the backing layer includes sequential unstitched backing portions and sequential stitched backing portions formed in an alternating and repeating pattern, the unstitched backing portions being essentially composed of backing warp threads only and the stitched backing portions being composed of the backing warp threads and extra warp threads being not composed of the intermediate warp threads; and the intermediate layer includes sequential intermediate portions composed of the intermediate warp threads only and connected to the stitched surface portions and the stitched backing portions in an alternating and repeating pattern, connecting warp threads of the intermediate layer connecting the stitched surface portions and the stitched backing portions being sheared.

6. A three-dimensional multilayer fabric, comprising a surface layer, a backing layer and an intermediate layer connecting the surface layer and the backing layer wherein the intermediate layer has a multi-layered structure where a multiple of fabric is separated each other and is composed of first intermediate portions and second intermediate portions and the surface layer and the backing layer are composed of their respective stitched portions where unstitched surface portions and unstitched backing portions are in contact with the intermediate layer, the surface layer and the backing layer are formed of two more warp threads and the first and second intermediate portions are composed of four more even-numbered warp threads, the unstitched surface portions and the unstitched backing portions are formed of two more warp threads, first and third stitched surface portions are formed of the unstitched surface portions and warp threads of the first intermediate portions and second stitched surface portions are formed of the unstitched surface portions and warp threads of the second intermediate portions, first and third stitched backing portions are formed of the unstitched backing portions and warp threads of the second intermediate portions and the second stitched backing portions are formed of the unstitched backing portions and warp threads of the first intermediate portions, the first and second intermediate portions are formed of two more warp threads to separate a multiple of a fabric, connecting warp threads of the intermediate layer exposed to the outside of the backing layer are sheared.

7. The three-dimensional multilayer fabric according to claim 6, wherein when surface warp threads are 1/2, backing warp threads are 3/4, first intermediate warp threads are 5/6/7/8 and second intermediate warp threads are 9/10/11/12, as indicated by harness numbers, the unstitched surface portions and the unstitched backing portions are essentially composed of 1/2 and 3/4, respectively, the first and third stitched surface portions of the surface layer are composed of 1/2/5/6/7/8, and the second stitched surface portion is composed of 1/2/9/10/11/12, the first and third stitched backing portions of the baking layer are composed of 3/4/9/10/11/12, the second stitched backing portion is composed of 3/4/5/6/7/8, and the first intermediate portions form one fabric layer using 5/6 and the other fabric layer using 7/8 to separate them each other, and the second intermediate portions form one fabric layer using 9/10 and the other fabric layer using 11/12 to separate them each other.

8. A three-dimensional multilayer fabric, comprising a surface layer, a backing layer and an intermediate layer connecting the surface layer and the backing layer wherein the intermediate layer has a multi-layered structure where a multiple of fabric is separated each other and is composed of first intermediate portions and second intermediate portions and the surface layer and the backing layer are composed of their respective stitched portions where unstitched surface portions and unstitched backing portions are in contact with the intermediate layer, the surface layer and the backing layer are formed of two more warp threads and the first and second intermediate portions are composed of four more even-numbered warp threads, the unstitched surface portions are formed of two more warp threads, the first and second intermediate portions are formed of two more warp threads to separate a multiple of a fabric, first and third stitched backing portions are formed of the unstitched backing portions and warp threads of the first intermediate portions and the second stitched backing portions are formed of the unstitched surface portions and warp threads of the second intermediate portions, the unstitched backing portion till the first stitched backing portion and the stitched portion are composed of the backing layer and warp threads of the second intermediate portions, the unstitched backing portion till the second stitched backing portion and the stitched portion are composed of the backing layer and warp threads of the first intermediate portions, the unstitched backing portion till the third stitched backing portion and the stitched portion are composed of the backing layer and warp threads of the second intermediate portions, the above procedure is sequentially repeated, and protruding portions exposed to the outside of the surface layer are removed.

9. The three-dimensional multilayer fabric according to claim 8, wherein when surface warp threads are 1/2, backing warp threads are 3/4, first intermediate warp threads are 5/6/7/8 and second intermediate warp threads are 9/10/11/12, as indicated by harness numbers, the unstitched surface portions are essentially composed of 1/2, the first intermediate portions form one fabric layer using 5/6 and the other fabric layer using 7/8 to separate them each other, and the second intermediate portions form one fabric layer using 9/10 and the other fabric layer using 11/12 to separate them each other, the first and third stitched surface portions of the surface layer are composed of 1/2/5/6/7/8, and the second stitched surface portion is composed of 1/2/9/10/11/12, the first and third stitched backing portions of the baking layer are composed of 3/4/9/10/11/12, the second stitched backing portion is composed of 3/4/5/6/7/8, the unstitched backing portion till the first stitched backing portion and the stitched portion are composed of 3/4/9/10/11/12, the unstitched backing portion till the second stitched backing portion and the stitched portion are composed of 3/4/5/6/7/8, the unstitched backing portion till the third stitched backing portion and the stitched portion are composed of 3/4/9/10/11/12, the above procedure is sequentially repeated.

10. A three-dimensional multilayer fabric, comprising a surface layer, a backing layer and an intermediate layer connecting the surface layer and the backing layer wherein the intermediate layer has a multi-layered structure where a multiple of fabric is separated each other and the surface layer and the backing layer are composed of their respective stitched portions where unstitched surface portions and unstitched backing portions are in contact with the intermediate layer, the surface layer and the backing layer are formed of two more warp threads and intermediate portions are composed of four more even-numbered warp threads, the unstitched surface portions and the unstitched backing portions are formed of two more warp threads, the intermediate portions are formed of two more warp threads to separate a multiple of a fabric, the stitched surface portions are composed of surface warp threads and a part of warp threads of fabric layers, the stitched backing portions are composed of backing warp threads and extra fabric layers, except for the warp threads of the fabric layers being composed of the stitched surface portions, connecting warp threads connecting the stitched surface portions and stitched backing portions are sheared.

11. The three-dimensional multilayer fabric according to claim 10, wherein when surface warp threads are 1/2, backing warp threads are 3/4, intermediate warp threads are 5/6/7/8, as indicated by harness numbers, the unstitched surface portions are essentially composed of 1/2 and the unstitched backing portions are essentially composed of 3/4, the intermediate portions form one fabric layer using 5/6 and the other fabric layer using 7/8 to separate them each other, the unstitched surface portions are essentially composed of 1/2/6/8, the unstitched backing portion are essentially composed of 3/4/5/7.

12. The three-dimensional multilayer fabric according to claim 1, wherein the warp thread and/or the weft thread is woven with a low-melting point yarn.

13. The three-dimensional multilayer fabric according to claim 1, wherein the low-melting point yarn is a grey yarn whose melting point is intentionally lowered by one more method selected from the group consisting of modification of molecular structure, copolymerization, blending, spinning process control or composite spinning so that the surface is allowed to be minutely fused by thermal treatment in the temperature range of about 120° C. to about 190° C.

14. The three-dimensional multilayer fabric according to claim 1, wherein the warp thread and/or the weft thread is a grey yarn in which a low-melting point yarn and a flame-retardant yarn are mixed or a composite fiber composed of low-melting point portions and flame-retardant portions.

15. The three-dimensional multilayer fabric according to claim 1, wherein the fabric is further thermally treated to achieve improved shape stability and enhanced stiffness.

16. The three-dimensional multilayer fabric according to claim 1, wherein the surface layer and the backing layer are formed into a mesh structure by weaving.

17. The three-dimensional multilayer fabric according to claim 1, wherein the intermediate layer is denser than the surface layer and the backing layer.

18. A cloth using the fabric according to claim 1.

19. An article using the fabric according to claim 1.

20. A blind using the fabric according to any one of claim 1.
